(19) United States
(12) Patent Application Publication
(10) Pub. No.: US 2005/0012861 A1
(43) Pub. Date: Jan. 20, 2005

(54) Processing a media signal on a media system

(76) Inventors: Christian Hentschel, Eindhoven (NL); Cornelis Conradus Adrianus Maria Van Zon, Coldspring (NL); Maria Gabrani, Gattikon (CH); Reinder Jaap Bril, Eindhoven (NL); Elisabeth Francisca Maria Steffens, Eindhoven (NL)

Correspondence Address: US Philips Corporation;Intellectual Property Department, PO Box 3001, Briarcliff Manor, NY, 10510, US

(21) Appl. No.: 10/498,135

(22) PCT Filed: Dec. 6, 2002
(86) PCT No.: PCT/IB02/05268

(30) Foreign Application Priority Data
Dec. 12, 2001 (EP) 01204857.5

(51) Int. Cl. H04N 5/44; H04N 11/04; H04N 11/02; H04N 7/12; H04N 7/04; H04N 11/20; H04N 7/01

(52) U.S. Cl. 348/553; 348/384.1; 348/441; 348/470; 348/725

(57) ABSTRACT

A method and a system of adaptive processing of a media signal on a media system. The media system can be VCR, TV, set-top box, storage or a display. The method includes the steps of requesting resources (1001) by an algorithm to provide a plurality of output quality levels, allocating a butlget (1002) to the algorithm, determining progress (1003) of the media signal, determining budget used (1004); and setting a quality level for media signal processing based on the progress, the allocated budget and the budget used (1005). The method further includes the steps of storing historical information (1006) about the processing; and further setting the quality level for media signal processing based on the stored historical information (1007). The historical information includes the budget allocated, the determined progress, the budget used, the set and or achieved quality levels. The progress quality levels are increased or decreased dependent on the ratio of the budget used to the allocated budget.

This invention relates to a method of processing a media signal on a media system, the method comprising the steps of
requesting a resource by an algorithm to provide a plurality of output quality levels;
allocating a budget to the algorithm to enable operating the algorithm at a first quality level of the plurality of quality levels.

The present invention further relates to a computer system for performing the method.

The present invention further relates to a computer program product for performing the method.

Non pre-published EP application EP 0109691 with attorney reference PHNL010327 describes a method of running an algorithm and a scalable programmable processing device on a system like a VCR, a DVD-RW, a hard-disk or on an Internet link. The application EP 0109691 uses resources to set a plurality of quality levels, and allocates a budget of resources. The method further runs the algorithm in order optimize the algorithm to ensure that the assigned budget equals the requested resources for the algorithm.

Algorithms for media signal processing are usually designed for a specific or static quality level, and have for many years been implemented on dedicated hardware for their specific environment. For instance, in traditional television receivers various, specific ICs are combined to perform e.g. color decoding for NTSC or PAL systems, noise reduction, or frame rate up-conversion.

On the software module side, current algorithms are designed for highest quality on given resources. They are not scalable and have a fixed functionality. The number of algorithms running in parallel is platform dependent and very limited.

The described method involves the problem that it is dedicated to the constructed purpose, as the prior art only processes media signals under given conditions to achieve predetermined quality levels. The prior art method adapts to predictable requirements for the media signal.

The described method further involves the problems that the progress of the media signal being processed can be too fast resulting in too low quality as resources are shared, or the progress of the media signal being processed can be too slow, i.e. the processing of a task or a function is not completed in time.

It is therefore convenient to provide a method that can adapt to changing requirements for a media signal, and to provide a method which by itself may further learn from changing requirements in a media signal. The changing requirements for the media signal may be a non predictable demand for quality level, and further the media signal itself may become unpredictably complex, thereby demanding more processing power.

Therefore, it is an object of the invention to provide a method that can automatically adapt to changing requirements for a media signal.

Another object of the invention is therefore to provide a method and a media system that can learn and adapt from previous processings of a media signal.

The media system may be an intelligent VCR, set-top box, a TV, a Personal Computer, a storage, a display and or any other electronic device which may process, present and or store a media signal. The media system may further be one that can process a media signal internally before the processed media signal is used or shown to a user of the media system.

The media signal may be representations of a video signal, an audio signal, a multimedia signal, a data stream or any other signal, which may be processed in the media system.

The objects are achieved by a method of the type mentioned in the opening paragraph, characterized in that the method further comprises the steps of
determining progress of the media signal being processed by the algorithm;
determining a budget used during operation; and
setting a second quality level for the media signal processing based on the progress, the allocated budget and the budget used.

As a result of the first step, the progress of the media signal being processed is determined. The advance of a certain task or function in the media signal processing over time is determined. It may be determined as the number of pixels processed, the number of audio packets processed, etc.

As a result of the second step, budget used during operation is determined. It may be determined in terms of percentage of the processing power, number of memory cells, bandwidth usage, co-processor options usage, etc.

As a result of the third step, a quality level may be set based on the progress, the allocated budget and the budget used. When a performance is known during the operation of the algorithm—i.e. use of budget compared to allocated budget—the method may know whether too many resources have already been used, or whether resources are still available. On that basis—as it may be assumed that higher quality may require more resources, and vice versa—the quality level may be set according to the estimated performance of the media signal. The performance of the media signal may be measured currently in order to, currently too, fine-tune use of resources and settings of quality levels.

By these three steps, the problems of the media signal being processed too fast or too slow are solved in that the resources for the processing are optimised, in order to complete a task or a function in time and/or in order to provide an optimum level of quality.

Additionally, by these three steps, the method better adapts to changing requirements in the media signal.

Other preferred embodiments of the method are described in claims 2 and 3.

Hereby, the method uses historical information about the processing of the media signal to set a quality level for media signal processing, i.e. the method may learn and further adapt to the results of previous processings of the media signal. A further advantage is that the method may thereby fine tune more quickly to a given media signal with a certain expected quality level, in that it may have and use historical information (settings, results, etc.) of a similar situation with the same or similar media signal with an achieved quality on the same or a similar level. The object of learning and adapting from previous processings of a media signal is hereby achieved.

Another preferred embodiment of the method is described in claim 4.

When less than the allocated budget is used in the processing of the media signal, this means that free resources may be available, and these may be used to increase the quality level, i.e. setting a higher level of quality.

Another preferred embodiment of the method is described in claim 5.

Therefore, if a situation of too high budget usage continues it may be expected that tasks or functions in the remaining processing of the media signal may not be completed in time. This means that resources may have to be freed and provided to help tasks or functions to be completed in time. The freeing of resources may be achieved by a decrease of the quality level of one or more of the tasks or functions in the processing of the media signal.

Another preferred embodiment of the method is described in claim 6.

Hereby, the objects of the invention previously stated and achieved can help media systems such as VCRs, TVs, set-top boxes, storages and displays, to adaptively fine-tune resources to quality and to the completion of tasks or functions in time.

Embodiments of the computer system and computer program product according to the invention are described in claims 7 and 8.

The invention will be explained more fully below in connection with preferred embodiments and with reference to the drawings, in which:

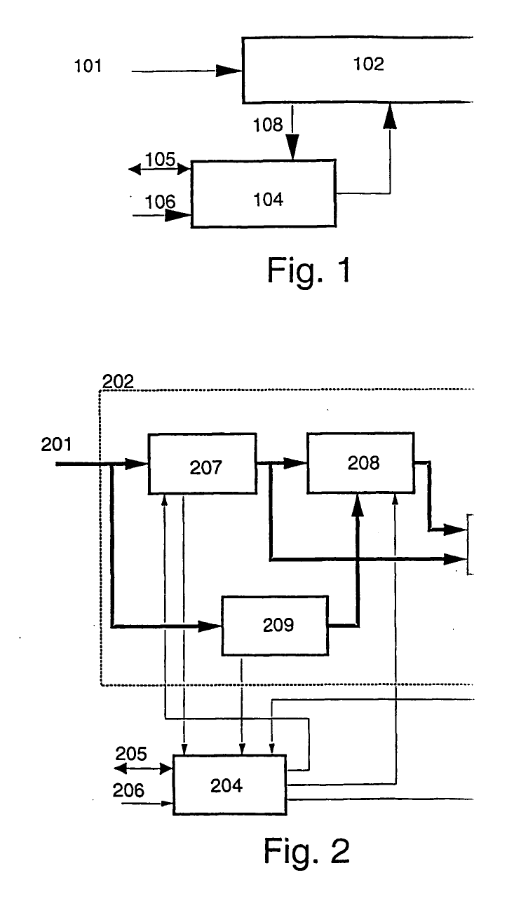

FIG. 1 shows the basic structure of the algorithm;

FIG. 2 shows a detailed diagram of a scalable algorithm;

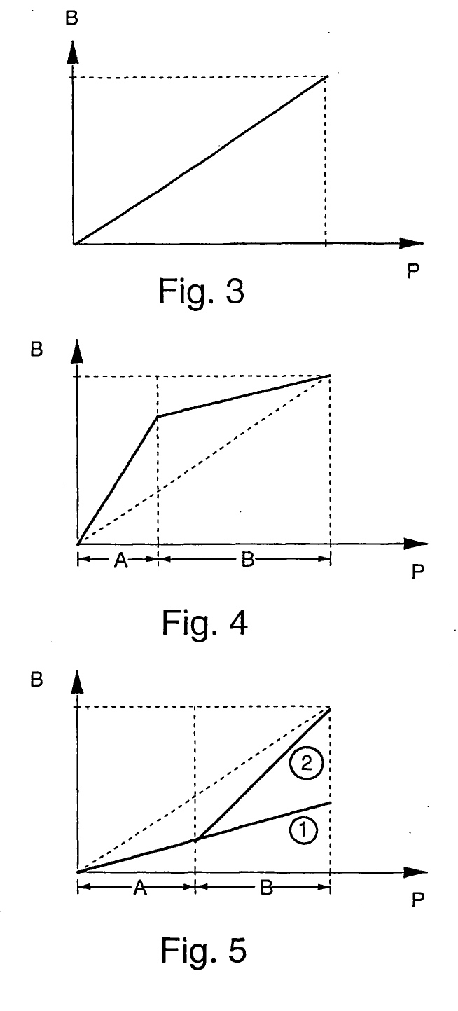

FIG. 3 shows a perfect match between an assigned budget and progress;

FIG. 4 shows an example of slow progress;

FIG. 5 shows an example of fast progress;

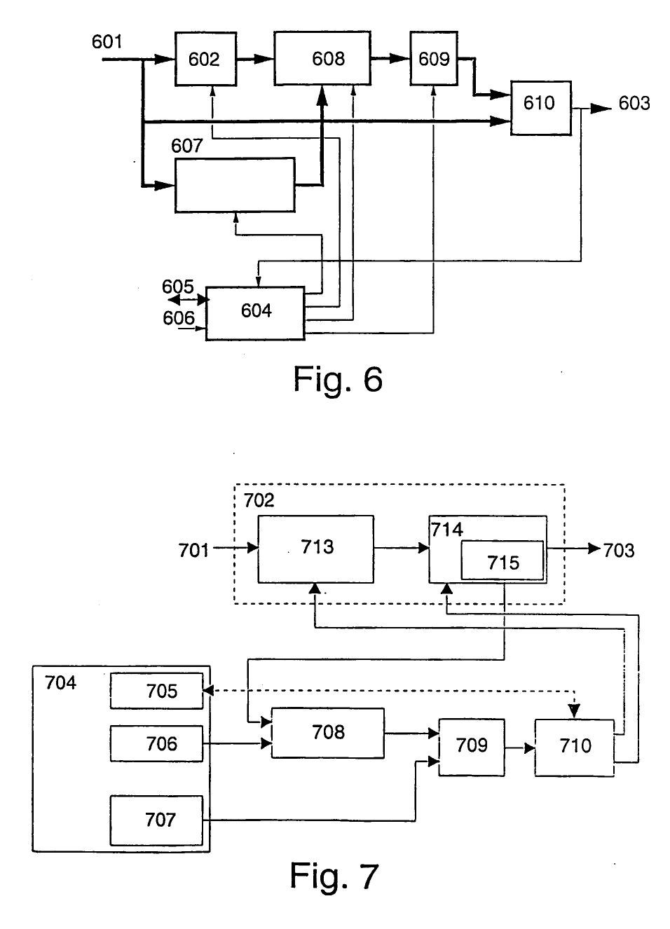

FIG. 6 shows examples of scalable functions on an algorithm for edge or sharpness enhancement;

FIG. 7 shows a functional example of a scalable algorithm with progress measurement in an adaptive environment;

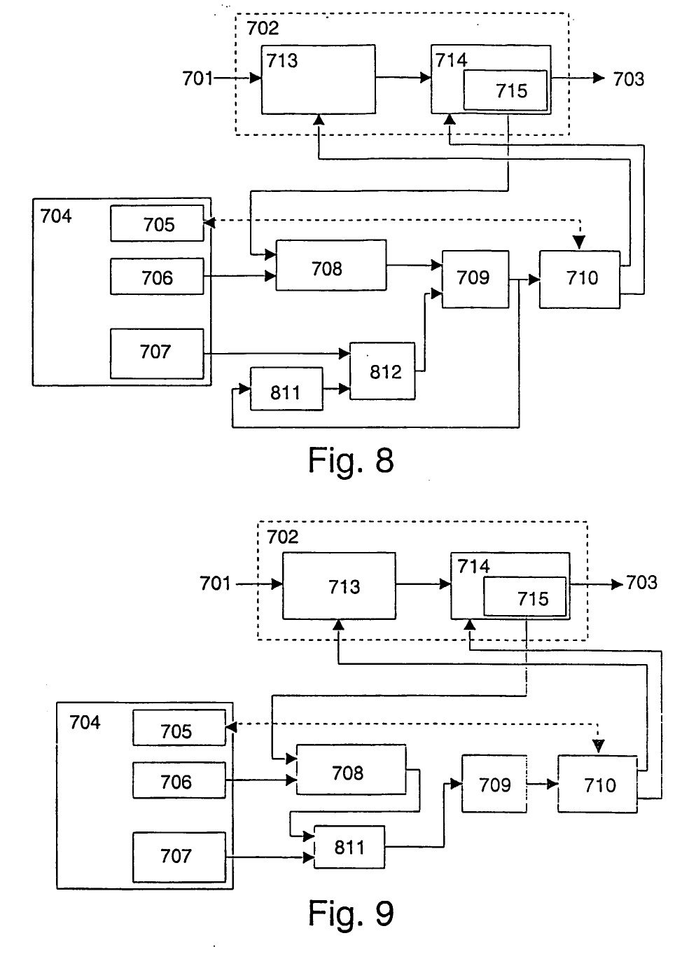

FIG. 8 shows another functional example of a scalable algorithm with progress measurement in an adaptive environment with history memory;

FIG. 9 shows another use of history memory; and

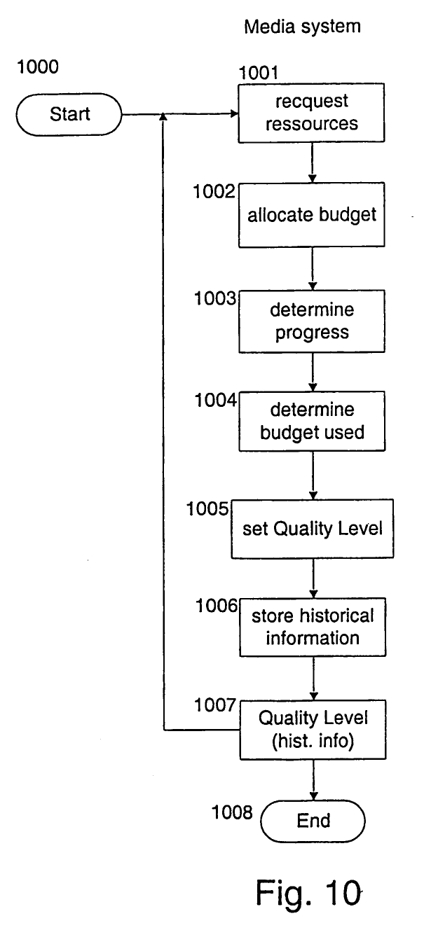

FIG. 10 shows a method of processing a media signal on a media system.

FIG. 1 shows the basic structure of the algorithm. In the figure a preferred embodiment of the invention is shown, reference numeral 101 the media signal in a media system may generally undergo a change—i.e. be transformed for various technical reasons as explained in more details in the following figures—to reference numeral 103, the media signal out. The media signal may be the signal or part of the signal undergoing the above-mentioned change or transformation.

The media system may be an intelligent VCR, set-top box, a TV, a Personal Computer, a storage, a display and or any other electronic device which may process, present and or store the media signal. Generally, the media system may be a system that can further process the media signal internally before the processed media signal may be used of, or shown to a user of the media system. The media signal may be representations of a video signal, an audio signal, a multimedia signal, a data stream or any other signal which may be processed in the media system.

Reference numeral 102, the block ‘algorithm for media signal processing’ processes the input signal, reference numeral 101, and provides a number of quality levels in exchange with the required computing resources. In addition, the progress in processing media signal information—i.e. the progress of the change of ‘the signal in’—processing to ‘the signal out’—is accessible from reference numeral 104, a block quality control.

Reference numeral 104, QC, the block ‘quality control’ translates the input control signal to the required settings for the functions in the block ‘algorithm for media signal processing’. Furthermore, information about various settings and resource requirements may be stored in e.g. a ‘look-up-table’ or a database, which may be externally accessible. The progress may also be reported to an external unit, which may be used for adaptive quality/resource control. At least two measures may be possible: on one hand a progress measure, PM, 108, and on the other hand a budget usage measure, BU, 106.

The quality level, QL, 105 can be set and retrieved from the quality control 104.

The budget used—as a term known in accounting—may therefore be a part of the assigned budget.

The assigned budget or the budget may be estimated and may be expressed in necessary available resources (e.g. CPU cycles, time) in order to perform a certain function or to perform more functions.

Correspondingly, the progress measure—which may be considered as the budget used—may be expressed in the measured actual use of resources, e.g. count of CPU cycles, time used and even more important the advance of a certain task or function in the media signal processing seen and measured over time. The advance or progress of a certain task may be time critical in that the result of the processing of that task—if provided too late in a critical real-time dependent media system—may have the effect that this result is either useless (due to a too late delivery so that it cannot be properly integrated in the media signal) or it may affect the media signal in an inconvenient way in that the remaining media signal may have difficulty in receiving and integrating such a result of a processed task when it arrives too late.

In the case when the scalable algorithm is only able to measure the progress (e.g. in the case of a media signal like a multimedia media signal: pixel processed, number of audio packets processed), then an external unit may provide the budget used. The budget used may be provided in a normalized form. The normalized form, i.e. the normalized budget, is the ratio of the budget used to the assigned budget. Knowledge of progress and assigned budget is needed to calculate the performance. By considering the value of the performance, the performance may be said to be high or poor. The situation of poor performance exists when more than the assigned budget is used. It may also be expressed such that the normalized budget is greater than one. On the contrary, a situation of high performance exists when less than the assigned budget is used. It may also be expressed such that the normalized budget is less than one. Where the normalized budget equals one then exactly the assigned budget is used, i.e. used budged equals the assigned budget. The performance may be currently computed during processing of a media signal. Thereby, the performance may vary over time.

However, it is import to note that the performance is considered regarding the progress of processing of a function or the summarized progress of the processing of multiple functions. The quality measure of a function or functions is another aspect and is related in a more complex manner to the performance. The handling of the quality aspect regarding settings, etc. will be described in the figures to come.

The performance calculation may be done within the 104, QC, quality control unit of the scalable algorithm, or externally.

If the scalable algorithm is able to measure the budget used BU, 106 (e.g. CPU cycles, time used) and progress PM, 108, the scalable algorithm may become more independent of an external control as the scalable algorithm can perform the measurements by itself The scalable algorithm may be able to perform a self-adaptation to the assigned budget through internal fine-tuning of functions without involving an external processing power or an external control.

FIG. 2 shows a detailed diagram of a scalable algorithm. The figure shows a more detailed diagram of a scalable algorithm 102 in the block of reference numeral 202 as compared to FIG. 1. The figure shows another preferred embodiment of the invention, here reference numeral 201 is the media signal in and reference numeral 203 is the media signal out. The algorithm for media signal processing may generally comprise different functions like reference numerals 207 through 210 corresponding to functions F1 through F4. Only four functions are shown, however another number of functions may be used in the algorithm as well. Some of them may be scalable for several quality levels, but others may not need to be scalable regarding quality. The mix of the requirements for a function to be scalable and for a function to be non-scalable may vary over time and may be dependent on actual media signal to be processed, e.g. an MPEG signal may vary as regards the need for processing power over time due to compression, data used, etc. The outcome of the scalable algorithm, the media signal out, may be dependent on the appropriate combination of the quality levels of the functions F1 through F4.

The control signal for quality level, QL reference numeral 205, may be as simple as the chosen quality level. The block ‘quality control’ QC, reference numeral 204, may itself have specific knowledge about the algorithm for media signal processing and the combinations of settings for the functions involved. This knowledge may be stored in a look up table or a database, which may be externally accessible. Additional information about the progress or performance in terms of the budget used, BU reference numeral 206, may be provided by the functions within the scalable algorithm. In a simple case for media signal with video information, i.e. video processing, just the processed pixels, block, chunks or series of data or may be counted. The counting may be part of one or more of the functions F1 through F4. Via the quality control block, QC reference numeral 204, this information may be externally accessed to calculate the current performance. Another option is to calculate the performance within the block of the scalable algorithm shown in reference numeral 202. The elapsed processing time for a task—as a measurement of progress—may be provided externally, or measured internally. With the knowledge of the current performance, adaptive fine-tuning of processing resources may be done to adapt to the assigned budget, wherein the quality levels of functions F1 through F4 may be increased or decreased. Typically, a demand for higher quality of a media signal may require more processing resources and vice versa.

FIG. 3 shows a perfect match between an assigned budget and progress. The figure shows the budget used—like BU of FIG. 1 or 2—over an assigned period to complete a task or a function. In an ideal case, the assigned budget—on the B axis—is used completely with the completion of the task of the function (P equals the progress axis). In reality, the performance may vary over the assigned period and normally the progress is either too slow as shown in FIG. 4 or the progress is unnecessarily fast as shown in FIG. 5.

FIG. 4 shows an example of slow progress in another preferred embodiment of the invention. Within a short progress period A, the main part of the assigned budget is already used. Continuing the same way, it can be predicted that the task completion cannot be done within the assigned budget. An option, depending on the overall media system resources, i.e. resources to be shared among the functions, is to grant a higher budget for this task or function. Another way, correcting for the poor performance, is to choose a lower quality level with lower resource requirements (period B) to stay within or close to the assigned budget. This is an example with only one correction, but in fact many correction points may be possible. It may also be possible to measure the performance when completing a task or a function. For the next assigned period, a decreased new (lower) quality level may be chosen to have a better match between the assigned budget and the progress.

FIG. 5 shows an example of fast progress. The figure shows another preferred embodiment of the invention, where high or fast progress with small budget use is achieved in period A. It is predictable that the assigned budget is too high and will not be used continuing at the same quality level (1). One possibility may be to decrease the assigned budget, i.e. use less resources, thereby freeing resources for other tasks or functions.

Alternatively, the task or the function may be accomplished by switching to a higher quality level, thereby—typically—more resources of the assigned budget will be used. In period B, curve (2) may depict an increased budget usage at a higher quality level. For the next assigned period, a new (higher) quality level may be chosen to have a better match between the assigned budget and the progress.

For FIGS. 3 through 5 it should be noted, that the process can be a continuous process with adaptations to the interrelated match between assigned budget and progress. For video processing it may be suitable to have points of end or begin of the beginning of a new image.

The way the functions and tasks of the FIGS. 1 through 6 are scaled regarding the providing of resources, when budget used is fine-tuned to the settings of the quality levels, may be considered as a method of adaptive process control.

In the following FIGS. 7 through 10, the same basic idea of adaptive process control applies.

FIG. 6 shows examples of scalable functions on an algorithm for edge or sharpness enhancement in a media signal e.g. a video signal. The figure shows another preferred embodiment of the invention. Here reference numeral 601 may be the media signal in and reference numeral 603 may be the media signal out. The algorithm includes the blocks with the following functions: FILTER, reference numeral 602, may be a filter, NONL function as reference numeral 608 may be a non-linear function, GAIN, reference numeral 609, may be a gain function; ADD, reference numeral 610 may be a function for an adder and NOISE MEAU, reference numeral 607, may be a function for measurement of noise. Generally, the functions like reference numeral 602, 607, 608, 609 or 610 and even more functions appropriate for the invention may be implemented as electronic circuitry and or as software components.

Reference numeral 602, the filter, may be a detail filter, which may extract higher frequency components; these may be added to the incoming video signal to increase the overall sharpness impression of the video signal seen by a user. Great amplitudes of video signals from the detail filter may cause clipping or other unwanted effects which may affect the quality of the video signal. The non-linear function and following gain may reduce such unwanted effects of the video signal. Since noise from high frequencies may also be increased, the noise measurement block may adapt the sharpness enhancement in dependence on the noise level measured by means of reference numeral 707. However, while each function like reference numeral 602, 607, 608, 609 or 610 may be individually scalable, the combinations of all settings for the functions involved may result in a huge design space with a corresponding huge amount of specific complex quality levels to control. Quality may be objectively measured by available measurement means within the media system shown, resulting in a more controllable set of quality levels. For smooth transitions between quality levels with lowest disturbances of the media signal, some quality levels may not be useful on a specific processing architecture. In addition to the described functions for the media signal processing, the scalable algorithm may further need means for external control like the quality control shown in FIG. 2. The quality control, QC 604 may also be a part of the algorithm for edge or sharpness enhancement in the video signal as it may be the block of reference numeral 604 with the belonging signals QL and BU, reference numerals 605 and 606, which are the control signal for quality level and BU budget used, respectively.

In a preferred embodiment of the invention the idea of allocating various resources over time as generally explained in FIGS. 4 and 5 may also be applied in the controlling of the functions of reference numerals 602, 607, 608, 609 and 610 in this figure. The control—which may be embedded as a part of the media system—may be done by means of reference numeral 604, QC the block ‘quality control’. The set and the achieved quality levels and the resources to use may vary, as the complexity of data in the media signal and functions may vary too, further the complexity of data and functions may be platform dependent, e.g. different media systems are realized on different hardware and or software platforms, and also dependent on the actual implementation. The settings of quality levels and resources to use may therefore vary. Reference numerals 602, 604, 607, 608, 609 and 610 of this figure may be implemented in a modular design for each of the blocks, hereby re-design and upgrades may be simplified, and flexibility and re-usability increase.

Algorithm dependent properties and parameters—like the previous mentioned set quality levels and the resources to use—may be stored in a look-up table or a database.

The available information in such a look-up table or database may also include parameters like quality level settings, signal-to-noise ratio, resource-needs (CPU cycles, memory, bandwidth, co-processor options), etc.

The external control and or the quality control may choose any version of the scalable algorithm. Due to the available information, a more sophisticated selection of quality levels may become feasible. The available hardware (CPU, co-processors, etc.) may be taken into account when choosing a version of the scalable algorithm. Some quality levels may provide the same output quality (algorithmic functionality), but may use different resources (e.g. CPU, memory, bandwidth, and co-processors). In that situation—when it is possible to choose among different quality levels (with different use of resources)— the lowest quality level (still providing the same output quality) may be selected to free resources for other functions.

The block QC, ‘quality control’, may translate this external quality request into a combination of different (quality) settings for the different functions. The feedback from the functions may provide information about the processed pixels in a video signal—which may be a measure of progress—and budget used or any other related technical information that helps to support the performance measurement. The performance measurement may be used to adaptively fine-tune the algorithm in a real-time environment embedded in a media system.

In FIGS. 7 through 9 the reference numerals with the same numbers generally have the following meanings. Reference numeral 701 maybe the media signal in, and correspondingly reference numeral 703 may be the media signal out. Reference numeral 702 may be the algorithm for media signal processing, reference numeral 704 may be a newly introduced block: an overall system control with the three blocks reference numerals 705, 706 and 707, where reference numeral 705 may be algorithm properties of the overall system control, reference numeral 706 may be the budget measure (BM) of the overall system control and reference numeral 707 may be quality levels (QL) of the overall system control. Reference numeral 708, P CALC, may be the performance calculation, reference numeral 709, QL ADJ, may be the quality level adjustment, reference numeral 710, OL SET, may be the quality level settings, reference numeral 713, F1, may be a function F1, reference numeral 714 another function denoted F2 which may be a function F2 with built in reference numeral 715, PM progress measure may be performed on the media signal out.

FIG. 7 shows a functional example of a scalable algorithm with progress measurement in an adaptive environment. This figure further extends the adaptive fine-tuning of quality levels from the foregoing figure. Reference numeral 702, the algorithm for media signal processing, includes only the minimally required parts, two scalable functions F1 and F2, and at least one progress measure, reference numeral 715 preferably at the last function F2 or measured at the media signal output.

Reference numeral 705, an overall system control, may optionally request information about the available quality levels and resource needs via reference numeral 710, QL SET, the block ‘quality level settings’, which may be part of the scalable algorithm. In addition to the static information, also the currently chosen quality level or settings may be reported. With the information of available quality levels and resource needs, the overall system control may choose an appropriate quality level (reference numeral 707) and assign a budget (reference numeral 706) accordingly.

The progress measure, PM (reference numeral 715) from the algorithm for media signal processing may report the number of already processed pixels per image, or the fraction of processed pixels per unit (e.g. field or frame in case of image processing of a media signal). The overall system control may assign the budget and may report the budget already used and or the ratio of the budget used from the assigned budget, which was previously defined as the normalized budget. The progress measure and the budget measure are needed for the performance calculation, P CALC. Depending on the current performance, the block ‘quality level adjustment’ may change the pre-selected quality level(s). The output may be transformed via the QL SET, (reference numeral 710) ‘quality level settings’ to the appropriate settings of the media signal processing functions F1 and or F2.

There may be further options to distribute the functionality between the ‘scalable algorithm for media signal processing’ as reference numeral 702 and the rest of the system shown in the figure. The minimally required components for the scalable algorithm of the figure may be F1, F2, the two functions for media signal processing, at least a progress measure PM preferably at the end of the processing chain, which may be just before the media signal output, and the quality level settings, QL SET.

The QC, ‘quality control’ block shown in FIGS. 1, 2, and 6 may further comprise the blocks QL SET ‘quality level settings’ and optionally PM, the ‘progress measure’.

A second option for the ‘quality control’ block shown in FIGS. 1, 2, and 6 may further be to include QL ADJ, the ‘quality level adjustment’ from FIG. 7.

A third option for the ‘quality control’ block from the FIGS. 1, 2, and 6 may further be to include the PM, the ‘performance calculation’ from FIG. 7.

A fourth option for the FIGS. 1, 2, and 6 may be for the ‘quality control’ block further to comprise BM, the ‘budget measure’.

FIG. 8 shows another functional example of a scalable algorithm with progress measurement in an adaptive environment with history memory.

Compared with FIG. 7, this figure, in another preferred embodiment of the invention, includes two additional blocks with reference numerals 811 and 812. Reference numeral 811, HIST MEM may be a ‘history memory’ and reference numeral 812, QL PRE ADJ may be ‘quality level pre-adjustment’.

Taking a history of previous processings of the media signal into account may greatly improve the performance of the scalable algorithm and of the media system. The history of previous processings may comprise the budget assigned, the budget used, the normalized budget, the progress measure, the performance, the set quality levels, the measured quality and or the need for changing parameters during the process. The history of previous processings may further comprise successful and or non-successful parameter settings regarding the achieved quality and or whether the assigned budget was sufficient.

The history information may be useful to provide fewer changes in quality levels, resulting in smoother and more reliable quality of the media signal out. Sudden error signals of the media signal generated by the media system itself like sudden motion judder, changes in sharpness, appearing aliasing etc., introduced by frequent quality level changes will be greatly reduced. Another advantage is that the algorithm may be able to self-adjust or fine-tune itself Even poor settings from the overall system control may be adaptively corrected for, with the advantage of an increase of system robustness.

The HIST MEM, the history memory may store the final quality settings and the function block may compare the history (e.g. average quality level over a number of processed units) with the assigned quality level from the overall system control. Depending on the differences, the requested quality level may be pre-adjusted by means of the new feature of this figure, namely reference numeral 812, QL PRE ADJ—the ‘quality level pre-adjustment’.

The pre-adjusted quality level may finally be assessed together with the run-time performance in the ‘quality level adjustment’ block of reference numeral 709, in other words, the pre-adjusted quality levels, reference numeral 812, may have lower frequent changes than the following ‘quality level adjustment’ block, reference numeral 709.

There may be still more options of distributing the functionality between reference numeral 702, the ‘scalable algorithm for media signal processing’, and the rest of the media system shown in the figure. The minimally required components for the scalable algorithm of this figure are: functions for media signal processing, at least a progress measure preferably at the end of the processing chain, i.e. before the media signal output, and the quality level settings.

The ‘quality control’ block in FIGS. 1, 2, and 6 may comprise the blocks ‘quality level settings’ and optionally ‘progress measure’. In this case, the history memory may comprise the run-time adaptation as part of the system control. The scalable media signal algorithm of FIGS. 1, 2, and 6 may still be considered simple as the advanced, adaptive processing is performed outside the scalable media signal algorithm.

Other options for the ‘quality control’ block in FIGS. 1, 2, and 6 may further be to include any of the blocks ‘quality level adjustment’, ‘performance calculation’, ‘history memory’, ‘quality level pre-adjustment’, and ‘budget measure’. With all mentioned blocks included in the ‘quality control’, the algorithm becomes able to fully self-adjust its properties. The overall system control may optionally request information from the ‘quality level settings’ block about the final quality level and quality settings.

With the above-mentioned options an even more advanced scalable algorithm with progress measurement in an adaptive environment is shown in FIG. 8.

FIG. 9 shows another use of history memory. The use of the history memory is another preferred embodiment of the invention. The run-time performance (progress, quality, etc.) and the assigned quality level may be stored and used for the quality level adjustments. As compared to FIG. 8, the reference numeral 812, the block ‘quality level pre-adjustment’ has been omitted in this figure. This may be a more straight forward approach when ‘the performance calculation’ and the ‘history memory’ together are used to determine the ‘quality level adjustment’ and may therefore result in a more robust behavior of the media system as opposed to the recursive loop in FIG. 8 between ‘history memory’ and ‘quality level adjustment’, which may lead to alternating quality level changes (alternating quality levels may be seen as disturbances in the media signal) in case of a poor design of the media system.

Generally, the functions or tasks shown and also the different blocks for processing or calculation, etc. may be implemented as electronic circuitry and or as software components. It may be in a form of software objects, circuitry like a dedicated CPU, a general purpose CPU, a CPU core, a coprocessor, an ASIC, a PAL or by use of discrete components. It may further be implemented in a combination of the above-mentioned electronic circuitry parts and software components. This also applies to the method of the next figure.

FIG. 10 shows a method of processing a media signal on a media system.

In step 1000, the method is started. Here different initialisations of the variables, parameters, quality level settings, etc. are set to default values of the functions comprising the method, which may be run on the media system by use of software and or a hardware implementation of the functions. After this starting step, the method proceeds to step 1001.

In step 1001, resources are requested by an algorithm to provide a plurality of output quality levels. Quality levels for media signal processing may be used to determine and to request resources for media signal processing, i.e. quality levels may be converted to resources. Generally, the higher the quality level is, the more resources may be requested and vice versa. The resources requested may be expressed by the number of memory cells to use, bandwidth use, loading of processing power, need for co-processor options or function calls, etc. Generally, resource may be expressed as requirement in the use of functionality of hardware and or software processing power of the media system.

In step 1002, a budget is assigned to the algorithm to enable the operation of the algorithm at a quality level. In some sense, step 1002 is similar to step 1001 in that in both steps resources are determined prior to the use. When a budget is assigned to the algorithm to enable operating the algorithm at a given quality level, resources needed for the media signal to be processed at the desired quality level are to be determined prior to the processing. Default data for budgeting from a lookup table and or a database may be useful. From the lookup table and or the database, the system may have some default estimates as to how many resources to assign or allocate when a media signal of a certain type is to be processed in a certain quality. For each function of the method or algorithm it may be determined how many and or which resources to use when the function is being processed to achieve the required quality. The resources for the media signal and or for each function to be processed may be expressed by estimating the loading of the CPU power and or the processing power of the media system. It may be determined as a percentage of the available processing power, number of memory cells to use, bandwidth use, need for co-processor options or function calls of the co-processor, e.g. time-consuming mathematical computations, and or other needs for available hardware in the media system such as digital signal processors. As an example, in order to assign or allocate a budget for a good analogous to digital conversion, i.e. to achieve a high quality level of a good conversion, many bits may be used in each sample, and a high sampling rate may further be required, thereby the budget assigned may require many resources in terms of processing speed and data storage. On the contrary, if the situation is that a less good analogous to digital conversion is sufficient, the budget assigned may require fewer resources, in that the number of bits and or the sampling rate may be decreased. However, the resources actually needed may vary over seconds or fractions of seconds, not only based on the required quality of the signal, e.g. a media signal such as the MPEG signal may due to the compressed nature of the signal and the demand for real time decoding, require the allocation of many resources in time critical fractions of seconds to be able to decode the MPEG signal in time. As mentioned in the foregoing, resources needed may vary over seconds, which can make it hard to actually allocate or assign a budget precisely. For this reason, as performed by this method, it can be a good idea, frequently, to re-estimate the resources requested, the budget usage and the budget allocation.

In step 1003, the progress of the media signal being processed may be determined. The progress of the media signal being processed may be expressed by the measured actual use of resources, e.g. count of CPU cycles, time used for the advance of a certain task or function in the media signal processing over time. The progress of the media signal being processed may be determined—e.g. in the event that the media signal is a multimedia media signal—as number of pixels processed, number of audio packets processed, etc.

In step 1004, the budget used during operation is determined. As opposed to step 1002 where the budget was assigned or allocated to the algorithm prior to use, in step 1004 the actual budget usage is determined, and thereby basically the same parameters may be considered in the steps 1002 and 1004. The actual budget usage may be determined as a percentage of the processing power used, number of memory cells used, bandwidth usage, co-processor options usage and or usage of function calls of the co-processor. All these measures of usage may show how much of the assigned or allocated budget is used. Basically, two situations may be involved, first, when the budget used is greater than the budget allocated, and, on the contrary, secondly, when the budget allocated is higher than the budget used. Additionally, a third situation exists, viz. the optimal situation where the budget used equals the budget assigned or allocated.

In step 1005, a quality level is set for media signal processing based on the progress, the allocated budget and the budget used. In order to have a simple relation between the budget used to the budget allocated, the term performance was previously defined. The performance may be computed as a budget in a normalized form. The normalized form, i.e. the normalized budget is the ratio of the budget used to the budget assigned or the budget allocated for a fixed period in a continuous process. Budget used may be understood as the use of resources in a certain state of progress during processing. The assigned budget or the budget allocated may be understood as the determined resources for the media signal to be processed, prior to the processing. The assigned budget or the budget allocated may also be considered as the assigned resources for a certain expected state of progress during processing. As the performance is the normalized budget, the performance is a unit-less value. The performance may be high or low. The situation of poor performance exists when more than the assigned budget is used. It may also be expressed such that the normalized budget is greater than one. It may be due to a higher loading of the processing power of the media system than expected or a higher quality demand for a function in a period; on the other hand, correspondingly, high performance is when less than the assigned budget is used, and thereby the normalized budget is less than one. The performance may be currently computed during the processing of the functions of the media signal. Thereby, the performance may vary over time. It is important to note that the performance may be considered regarding the progress of processing of a function or the summarized progress of the processing of multiple functions. The setting of a quality level for media signal processing may further be based on the estimated performance of the media signal. Generally, when the performance is high, more resources may be used to provide a better quality, i.e. the quality level adjustment block and the quality level setting of FIGS. 7 through 9 may be used to set a higher quality level for the functions. Correspondingly, when the performance is low, probably a too high quality level may have been set as too many resources are used to achieve the high quality level. Consequently, the functions may be forced to provide a lower quality of the media signal out, i.e. the quality level adjustment block and the quality level setting of FIGS. 7 through 9 may have to be used to set another lower quality level for one or more of the functions. The performance of the media signal with a value less than one may be used to increase the quality level of the media signal to be processed. In other words, the quality level of the media signal to be processed is increased, when the budget used is smaller than the allocated budget. Correspondingly, the performance of the media signal with a value greater than one may be used to decrease the quality level of the media signal to be processed. In other words, the quality level of the media signal to be processed is decreased, when the budget used is greater than the allocated budget

However, it may further be considered in the adjustments of the quality levels and other adjustments of resources how the progress of the media signal is. Shortly, the progress may be expressed in terms of the time used for the advance of a certain task or function, and in the case of a multimedia media signal, the progress may be expressed by the number of pixels processed and or the number of audio packets processed. In other words, the progress may determine the advance of a certain task or function in the media signal processing seen and measured over time. The advance or progress of a certain task may be time critical in that the result of the processing of a task, if provided too late, may have the effect that this result may be useless due to a too late delivery, or it may affect the media signal in an inconvenient way in that the remaining media signal may have difficulty in receiving and integrating such a result of a processed task when it arrives too late. In other words, apart from the adjustments of the quality levels to fine-tune resource usage to budget, the resources may also be fine-tuned in order to speed up or slow down a task or a function in order to ensure that the progress, i.e. the completion of a task or function, is reached in time or is not reached too early.

In step 1006, historical information about the processing of the media signal may be stored. The historical information about the processing of the media signal may generally comprise previous results of processings of the media signal, the parameter settings prior to and during the processing and the results achieved. Generally, the historical information about the processing of the media signal may comprise the budget allocated, the determined progress, the budget used, set quality levels and achieved quality levels. Further the historical information may comprise the normalized budget, i.e. the performance, and or whether there was a need for changing parameters during the processing. The historical information about the processing of the media signal may further comprise successful and or non-successful parameter setting regarding the achieved quality and or whether the assigned or allocated budget was sufficient for the completion of tasks or functions in time.

In step 1007, the settings of the quality levels for media signal processing may further be based on the stored historical information. Step 1007 may generally be understood as a further extension of step 1005 of setting quality levels. As the historical information about the processing of the media signal may keep track of the budget assigned and used, the progress, the performance, the quality level settings, the achieved quality, successful and non-successful parameters, etc., the historical information may generally be used to quickly select proper quality levels and sufficient assigned budgets for the functions of the method. Hereby, the method may only have to change the settings of the quality levels a few times as the method may have been started from a nearly optimised state. Hereby, the result is a smoother media signal with a reliable quality of the media signal out.

Normally, the method will start from the beginning in step 1001 again, as long as the media system wherein the method is running is powered. Otherwise, the method may terminate in step 1008, however when the media system is again powered, the method may proceed from step 1001 again.

When the steps are currently executed continuously, the method may self-adapt in real time to varying media signals and changing requirements of quality levels. The method described is therefore a scalable algorithm with progress measurement that allows the adaptation of quality requirements versus processing resources on a given hardware and or software architecture on a media system, it may support different software and/or hardware platforms for media signal processing, it may be easily controllable by an integrated control device of the media system with several predefined settings as good starting points for self adaptation, and the method may access and use the information of the achieved progress of at least one function block. The method may be run in different areas of media processing, such as processing of media signals representing image, video, graphics, and or audio, and it may be designed in several configurations to allow for different quality levels and or different media signal in exchange with the required processing resources.

All the foregoing figures shown may represent media signal processing in VCRs, Televisions, Set-top boxes, multimedia PCs, storage, displays, and or in other application where media signal processing may be performed for the transformation of the media signal.

Note the wording “assign” and “allocate” have generally been used with respect to the budget to cover the same meaning.

A computer readable medium may be magnetic tape, optical disc, digital video disk (DVD), compact disc (CD or CD-ROM), mini-disc, hard disk, floppy disk, smart card, PCMCIA card, etc.

1. A method of processing a media signal on a media system, the method comprising the steps of:
requesting a resource (1001) by an algorithm to provide a plurality of output quality levels;
allocating a budget (1002) to the algorithm to enable operating the algorithm at a first quality level of the plurality of quality levels;
characterized in that the method further comprises the steps of:
determining progress (1003) of the media signal being processed by the algorithm;
determining a budget used (1004) during operation of the algorithm; and
setting a second quality level for media signal processing based on the progress, the allocated budget and the budget used (1005).

2. A method according to claim 1, characterized in that the method further comprises the steps of
storing historical information (1006) about the processing of the media signal; and
setting the second quality level for media signal processing further based on the stored historical information (1007).

3. A method according to claim 2, characterized in that the stored historical information comprises at least one of the budget allocated, the determined progress, the budget used, the first and second quality levels.

4. A method according to claim 1, characterized in that the method further comprises the step of
increasing the quality level of the media signal to be processed by the algorithm when the budget used is smaller than the allocated budget.

5. A method according to claim 1, characterized in that the method further comprises the step of
decreasing the quality level of the media signal to be processed by the algorithm when the budget used is greater than the allocated budget.

6. A method according to claim 1, characterized in that the media system is one from the group comprising VCR, TV, set-top box, storage and display.

7. A computer system for performing the method according to any claim 1.

8. A computer program product comprising program code means stored on a computer readable medium for performing the method of claim 1 when the computer program is run on a computer.
